(19) United States
(12) Patent Application Publication
(10) Pub. No.: US 2006/0112397 A1
(43) Pub. Date: May 25, 2006

(54) Cross-architecture software development

(76) Inventors: Makaram Raghunandan, Northboro, MA (US); Rajendra Yavatkar, Portland, OR (US); Mark L. Skarpness, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/993,326

(22) Filed: Nov. 18, 2004

(51) Int. Cl. G06F 9/46; G06F 9/44

(52) U.S. Cl. 719/313

(57) ABSTRACT

In general, in one aspect, the disclosure describes a method that includes providing a user interface common to multiple development tools, different ones of the development tools dedicated to different processor architectures. The method also includes enabling communications between the user interface and the development tools.

### BACKGROUND

The rapid evolution of the Internet has created an increasing need for sophisticated services and high bandwidth connectivity. Examples of such sophisticated services include differentiated quality of service, secure communications (over multiple access technologies such as dialup, cable, digital subscriber line (“DSL”), Ethernet 802.11 hot spots and third generation (“3G”) mobile wireless), load balancing traffic streams between multiple servers, and real-time monitoring of traffic, e.g., to determine usage patterns, billing or prevent hostile network behavior (such as intrusion detection, denial of service attacks and virus scanning). These value-added services, along with need to maintain legacy support, have led to an unprecedented amount of protocol complexity. Supporting such complex protocol suites requires intelligence throughout the network infrastructure and is causing large-scale changes to the design and architecture of networking systems. Those changes include a migration towards networking systems designs based on multi-processor blades in which different processors with different capabilities are tightly coupled to provide the services needed. Because development tools are focused on individual processor architectures, however, there is an increased number of software development environments with which a system developer must contend.

### DESCRIPTION OF DRAWINGS

FIG. 1 shows an exemplary development platform configured to support a cross-architecture development suite (“CADS”).

FIG. 2 shows a high-level depiction of an exemplary integrated development environment provided by the CADS.

FIG. 3 shows a high-level architectural view of the CADS according to an exemplary embodiment.

FIGS. 4A-4C show exemplary CADS usage scenarios.

FIGS. 5A-5C show different screens of an exemplary system-level user interface (SLUI) provided by the CADS.

FIG. 6 shows an example of a chassis view and blade view provided by the SLUI for a bladed system.

FIG. 7 shows a design cycle optimized by the use of the CADS.

FIG. 8 shows a sample computer system suitable to be programmed with embodiments of the CADS.

### DETAILED DESCRIPTION

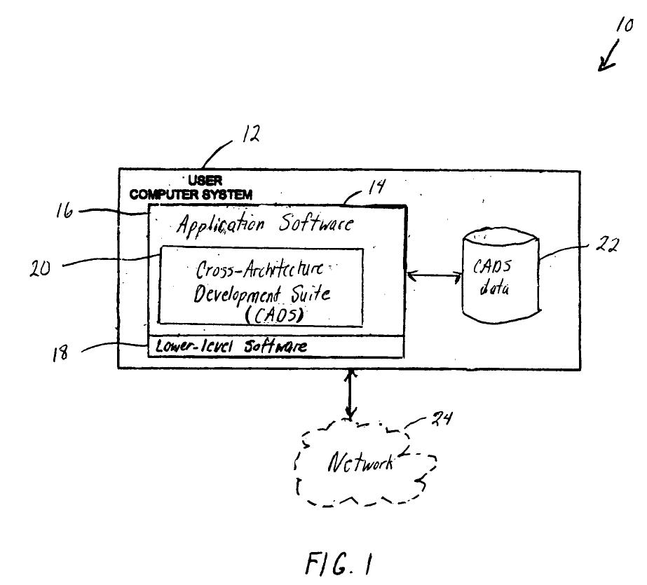

FIG. 1 shows an exemplary development platform 10 that includes a user computer system 12 configured with software 14. The software 14 includes both upper-level application software 16 and lower-level software (such as an operating system or “OS”) 18. The application software 16 includes a cross-architecture development suite (“CADS”) 20 that enables system-level software development for a target system based on multiple hardware components as well as different communications processing architectures. The CADS 20 contains software development tools used to develop application code to run on the different communications processing architectures.

The communications processing architectures may include general purpose computing architectures such as the Intel® Architecture (“IA”), examples of which include the Intel® Pentium™ and Xeon™ processors. The communications processing architectures can further include such architectures as the “Microengine” (“ME”) cores and Intel® Xscale™ core (“Xscale”) found in the Intel® IXC and IXP chips. Development tools for such communications processing architectures may be provided by the chip developer and/or by third-party vendors. They may be open sourced as well. Further, other tools such as configuration tools for chips such as framers and switching engines (for example, the Intel® IXF framer and IXE switching engine) may be supported as well. Thus, the CADS 20 enables cross-architecture interactions, including interactions between tools for different processing architectures, or, between a system level tool and a tool for a given processing architecture. Other application software may be installed on the computer system 12 as well.

A user's target system may include a mixture of communications processing architectures and processors. There may be multiple processors (similar or different ones) on the same blade or chassis, in the case of a bladed system design. The CADS 20 integrates the heterogeneous development environments for the individual communications processing architectures into a single, multi-chip integrated development environment (“IDE”) to provide a unified development approach to the target system (be it blade, sub-system or chassis) under development. An IDE that spans these multiple communications processing architectures provides much value to the user.

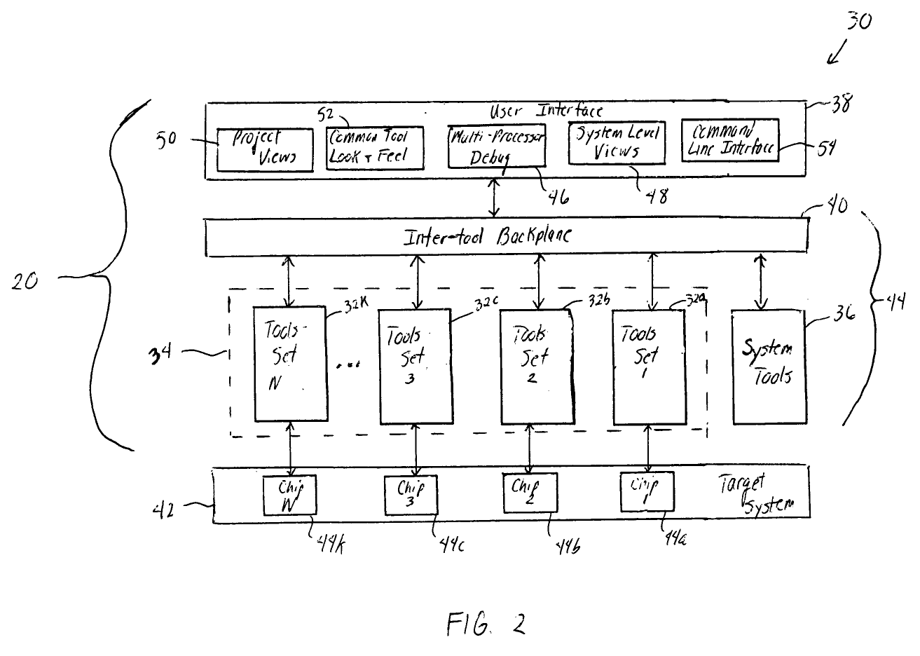

The multi-chip IDE can include a tool, set of tools, or multiple sets of tools (as will be shown in FIG. 2) that run on a software development platform, e.g., a PC. The IDE ties together the underlying silicon software tools into a coherent single development user experience. In addition to the different silicon components, the environment takes into account the different phases of silicon software development (evaluation, development, simulation and execution), each of which may use a different tool, as described later.

Still referring to FIG. 1, the system 12 also includes one or more databases 22 to store CADS related data. The databases may include static debug data, for example, data produced at build time (such as operand maps). The databases may further include a simulation history that captures historical information generated over time, such as data generated during a simulation session. The system 12 may be operated in standalone mode or may be coupled to a network 24.

Referring now to FIG. 2, as shown in system 30, key components of the CADS 20 include the following: tools including individual development tools sets 32 (collectively, development tools 34) and systems tools 36; a user interface 38 and an inter-tool (or software) backplane 40. The term “inter-tool backplane” refers to a set of features and functions that act as the backbone for cross-architecture inter-tool interaction. The inter-tool backplane 40 thus provides the “glue” to connect the individual development tools sets 32 and system tools 36 to each other and to the user interface 38. The tools sets 32 (shown in the figure as tools sets 1 through ‘N’ and corresponding to reference numerals 32a, 32b, 32c, . . . 32k) are targeted at ‘N’ individual chips 42 used on a target system 42. Thus, tools set 1 is targeted at chip 1, tools set 1 is targeted at chip 2, tools set 3 is targeted at chip 3, . . . , and tools set ‘N’ is targeted at chip ‘N’. Each chip is a silicon component that contains a different processing architecture (or in some cases, multiple processing architectures) or is a device requiring special tools support. In one example target system that includes four different silicon components, and using the architectures and devices mentioned above for illustrative purposes only, chip 1 could be an IA processor, chip 2 could be an IXC processor, chip 3 could be an IXP network processor and chip ‘N’ (chip 4 in this example) could be some other device, such as an IXF framer or IXE switching engine. Each tools set 32 may encompass a wide variety of individual tools such as simulators, compilers, assemblers, linkers, code generators, debuggers, packet generators and the like. The tools and inter-tool backplane are indicated collectively by reference numeral 44.

The user interface 38 provides a common user interface through which system-level user interactions can occur. It provides system-level capabilities for block diagram creation, project management, build management and debug 46, system-level views 48 to support these capabilities; project views 50 and a common graphical user interface (“GUI”) 52 to provide a common “look and feel” for all of the system-level tools. A command line interface (“CLI”) 54 may be included as part of the user interface 38 as well. In addition, individual tools may have customized graphical views that are appropriate for their specific functions. The user interface 38 also contains common components, for example, a code editor, used by multiple tools. The user interface 38 may be implemented with a common user interface framework such as Eclipse. Eclipse is a Java-based (multi-platform), open source development environment.

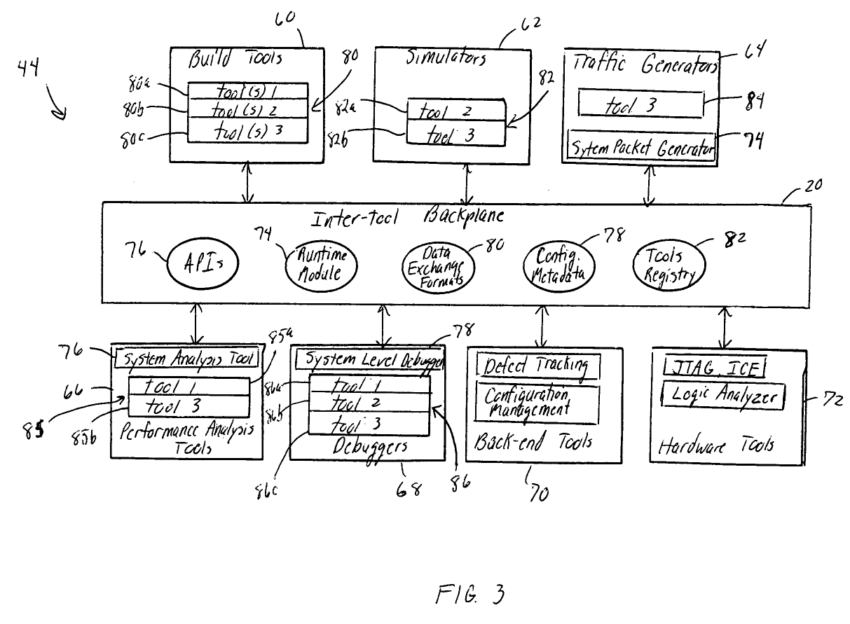

FIG. 3 shows a high-level architectural view of the inter-tools backplane 40 and tools portion of the CADS 20 in which the individual tools 32 that are specific to different processing architectures are mapped to functional tools categories. The tools are functionally decomposed into tools categories that are common across all the target chips. For each of these tools categories, the CADS 20 provides system-level capabilities that encompass the underlying processing architectures. These system-level capabilities are provided either by combining information from underlying tools, or by creating a tool that is common across different processing architectures. The inter-tool backplane 40 provides the services these tools categories need to provide system-level solutions to the CADS user.

The functional categories of tools include build tools 60, simulators 62, traffic generators 64, performance analysis tools 66, debuggers 68, back-end tools 70 and hardware tools 72. The build tools 60 are tools used to generate the executable code for the target architecture. Tools such as assemblers and compilers belong in this category. There may be other tools such as automatic code generators and graphical design assistants that could also be part of this group of tools. The simulators 62 are architectural or cycle accurate models of the silicon which can be used to perform software test and validation before the availability of target boards or target silicon. Traffic generators 64 are a class of tools specific to networking applications and can be used to generate a rich set of inputs to aid in testing of the system and software. The performance analysis and tuning tools 66 include tools which are used for feasibility analysis at the evaluation/design stage, and tools which are used for performance tuning of the code on target hardware. The debuggers 68 are used to assist in the debug of the code via source level debugging capabilities. The back-end tools 70 include tools used to assist in project planning and management, including tools for configuration management, defect tracking and release engineering. The hardware tools 72 are tools that are used to debug target hardware, e.g., tools such as ICE and JTAG. Other types of tools may be supported as well.

Some of these functional tool categories include system-level tools common to all processing architectures. For example, in the illustrated embodiment of FIG. 3, the traffic generators 64 include a system packet generator 74, the performance analysis tools 66 include a system analysis tool 76, and the debuggers 68 include a system-level debugger 78. Other tools in a given tool category are specific to a particular architecture. For example, and using chips 1-3, and tools sets 1-3 discussed above with reference to FIG. 2, the build tools 60 may include build tools 80 from the tools sets 1-3, the simulators 62 may include simulator tools 82 from tools sets 2 and 3, the traffic generator tools 64 may include a traffic generator too 84 from tools set 3, the performance analysis tools 66 may include performance analysis tools 85 from tools sets 1 and 3 and the debuggers 68 may include debugger tools 86 from tools sets 1-3. In the illustrated example, if chips 1-3 correspond to the IA processor, the IXC processor and IXP network processor, respectively, then the individual tools represented in the functional categories are as follows. The build tools 80 would include IA build tools 80a, IXC build tools 80b and IXP build tools 80c. The build tools in each case would include C and/or C++ compilers and assemblers. The simulators 82 would include an Xscale simulator 82a and an IXP transactor (simulator) 82b. The traffic generator tool 84 would be a traffic generator tool for the MEs in the IXP processor. The performance analysis tools 85 would include an IA tool (such as VTune) 85a and an IXP/ME tool (such as ADT) 85b. The debuggers 86 would include an IA debugger (such as a GNU debugger) 86a, an IXC debugger (which could also be a GNU debugger) 86b and an ME/IXP debugger 86c. Of course, it will be appreciated that the individual tools represented in the different functional tools categories will vary with the number of different tools sets in the CADS 20 and the nature of the tools sets and targeted architectures (e.g., a simulator or traffic generator tool may exist for one architecture but not another).

The inter-tool backplane 40 provides the mechanisms needed for inter-tool cross-architecture interactions. These interactions can be accomplished by means of a run-time module or interaction broker 74, application program interfaces (APIs) 76 exposed to the system level and architecture specific tools, configuration files 78, common data exchange formats 80 and a tools registry 82. These backplane components will be described in further detail below.

Several observations can be made with respect to the logical partitioning of the tools as illustrated in FIG. 3 and discussed above. Most of the cross-architecture interactions occur between tools that belong to the same category. For example, an Xscale simulator could interact with a ME simulator. Most cross-category interactions occur between tools within a given tool set (i.e., tools that target the same processing architecture). For example, only a debugger in tool set ‘N’ may interact with a simulator in tool set ‘N’. Thus, the nature of the inter-tool interactions limits the cross-architecture interactions to a small set of tool combinations. Tools within a category share common behavior and their interactions with other tools can be defined by the APIs 76, data exchange formats 80 and configuration parameters and metadata contained in the configuration files 78 of the inter-tool backplane 40. The processing architecture specific interactions (those that are needed between tools that target the same processing architecture) may be separated from the system-level interactions. The system-level interactions have sufficient commonality (between tools within a category) such that it is possible to create a common backplane definition (in terms of API, etc.) that is a superset of individual processing architecture needs. Thus, the logical partitioning provides the basis for the interaction model implemented by the inter-tool backplane 40.

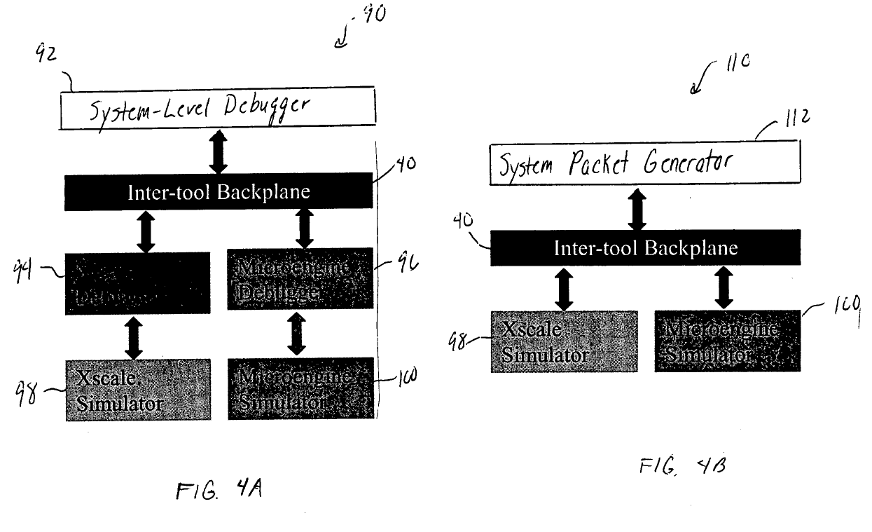

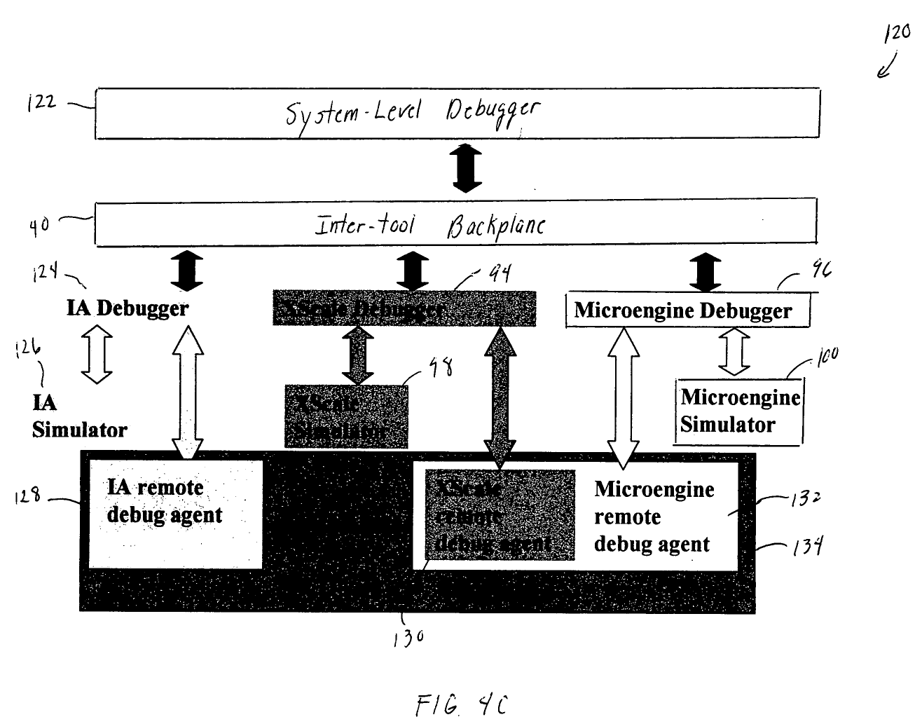

FIGS. 4A-4C show examples of different cross-architecture interactions. FIG. 4A shows a debugger interaction 90 involving a system-level debugger 92 built on top of existing architecture-specific debuggers shown as an Xscale debugger 94 and ME debugger 96. The ME debugger 96 may be a debugger provided as part of the IXA Developer's Workbench and the Xscale debugger may be the GNU debugger (“GDB”). The system-level debugger 92 interacts with the individual debuggers 94, 96 through the inter-tool backplane 40. The individual debuggers 94 and 96 interact directly with respective simulators 98 and 100. As an example, system level debugger 92 may issue a “examine” debug command to the XScale debugger 94 by calling a backplane 40 API function specifying the XScale debugger 94 as the target of the command. The backplane 40 may, in turn, call a function of an API exposed by the XScale debugger 94. Information can also flow in the opposite direction. For example, in response to an “examine” debug command, the XScale debugger 94 can return the “examined” data by calling a backplane 40 API. The backplane 40, in turn, can invoke an API function exposed by the system level debugger 92.

In addition to data flowing vertically, data can also travel horizontally between tool peers. For example, XScale debugger 94 could pass data to Microengine debugger 96, by invoking a backplane 40 API function passing the data and identifying the Microengine debugger 96 as the target. The backplane 40 could then invoke a Microengine debugger 96 API function to deliver the data. As an alternative, the XScale debugger 94 could use the data exchange features 80 to pass the data. As another alternative, the tools 94 and 96 could be programmed to by-pass the backplane and directly interact.

FIG. 4B shows another example that features packet generator interaction 110. In the interaction 110, a system packet generator 112 provides packet data as input for simulation and validates the simulated output. The packet generator 112 interacts with different individual simulators (shown as the Xscale simulator 98 and ME simulator 100, respectively) through the inter-tool backplane 40. FIG. 4C shows yet another example debugger interaction 120 in which a system-level debugger 122 interacts with three different individual debuggers, shown as IA debugger 124, Xscale debugger 94 and ME debugger 96, respectively, through the inter-tool backplace 40. As in the example shown in FIG. 4A, each of these debuggers 124, 94, 96 interacts directly with respective simulators 126, 98, 100. In this debug scenario, hardware debug is also provided. Thus, the debuggers 124, 94, 96 interact with respective remote debug agents 128, 130, 132 residing on hardware 134 (for example, an evaluation board, or target system board).

The tools in an integrated environment interact with each other and the inter-tool backplane in various ways. These interactions occur because of some shared state, shared hardware components and inter-dependency. The inter-tool interactions use functionality provided by the inter-tool backplane. In particular, the inter-tool backplane 40 enables interactions between tools of different tools, that is, cross-architecture interactions. Different components of a tool may not use the inter-tool backplane for the communication. Instead, they may use interactions specific to those tools. Also, the interactions across different tools of a given tools set are specific to that tools set and may not involve the inter-tool backplane 40.

In the example shown in FIG. 4C, the XScale simulator 98 and MEs simulator 100 together simulate an IXP design and the IA simulator 126 acts as a host processor. In this scenario, the simulator tools communicate to each other any changes to memories, changes in common CSR registers, exchange of packets, and so forth. One tool may interact with another to read and write the state maintained by the other tool. More specifically, in the example shown, the XScale and MEs simulators share same memories (e.g., SRAM), some hardware blocks and CSRs. They can also send signals to each other affecting each other's simulation. In addition, the IA debugger 124 interacts with the XScale debugger 94, sending route update messages, management packets and other information. These cross-architecture interactions between tools are handled by the inter-tool backplane 40, which provides the data exchange formats, configuration parameters and standard APIs needed for interaction between these tools in an integrated system.

The functionalities provided by the inter-tool backplane 40 can be classified into two categories, static bindings and run-time interactions. The inter-tool backplane 40 provides mechanism by which tools can statically bind to exposed APIs of other tools. These static bindings take place at load time of the tools. The components of inter-tool backplane 40 that facilitate static bindings include the configuration files 78; the tools registry 82; and the debugging APIs 76. The run-time interactions are interactions between tools that use inter-tool backplane 40 at run-time. Example of the run-time interactions include inter-tool backplane calls, APIs, tools packet exchanges, and so forth. The components of CADS backplane facilitating run-time interactions include the data exchange formats 80 and the APIs 76.

The inter-tool backplane 40 maintains a system-level configuration in the configuration files 78. This system-level configuration contains configuration information like syntax coloring, auto-complete, error listing and tools invocation details. Individual tools leverage information from the system-level configuration file. Individual tools can maintain their independent configuration files, which are not visible to the inter-tool backplane 40. The tools invocation details include such information as the file name to run (each tool will have a separate file for each chip type), command line options supported, number of processors of each kind used in a project, clock speeds for processor(s), memory, media, amount of memory on the system, interconnection information and “schematic” connection between components. The configuration files 78 can also include project system configuration data. The project system configuration data can include build instructions and object file to be loaded for each processor.

The tools registry 82 provides a central location where all tools are registered. Every tool registers itself to the inter-tool backplane 40 at installation time. The registry information in the tools registry 82 is maintained to identify tools and their attributes, similar to the way Microsoft Windows maintains registry information of all programs installed in the operating system. The inter-tool backplane 40 uses this information to identify tools with which it needs to interact. The tools registry 82 gives information as to when to invoke a particular tool and can determine, for project files, which tool is to be used to open the file. The tools registry 82 maintains the following information about each registered tool: i) a tool type, e.g. build tool, simulator tool, etc.; ii) tool name; iii) tool version number; iv) tool location; v) location of files (such project files or library files required for projects running on the tool); vi) a pointer to the tool's configuration file; and vii) a list of supported file extensions for the tool.

The inter-tool backplane 40 brings together tools that are targeted at individual silicon components to achieve these system level capabilities. The inter-tool backplane 40 manages tool interactions in a consistent manner. For system-level debugging (as illustrated in FIGS. 4A and 4C), it may be necessary to stop two different processors when a breakpoint is reached in one of them, and watch data changes on both of the processors. The APIs 76 defined in the inter-tool backplane 40 are used to manage these interactions. Some the APIs that are needed are APIs used for session control such as start/stop of debug session, handling run control such as break and continue, and reporting debug events such as breakpoints and data watch updates.

The individual tools expose a set of APIs to the inter-tool backplane for certain functionalities, for example, in the case of a debugger, functionalities like starting debug, stopping debug, reporting error condition and so forth. In addition, the inter-tool backplane binds APIs exposed by a tool to the other tools such that they can interact with each other. In one embodiment, each tool defines the following APIs:
1. add_breakpoint( ), delete_breakpoint( ): These functions are used to add/delete breakpoints.
2. enable_breakpoint( ), disable_breakpoint( ): These functions are used to enable/disable breakpoints.

Data are exchanged between tools in several formats. A tool has a format to store debug files, to store load files, as well as input and output packets. Since these formats are tool-specific, some or all are standardized (by the data exchange formats component 80) in such a way that those tools can understand each others' format. For an example, a single packet generator and analyzer can be used across IXP and IA tools if these tools have the same exchange format for packet data. Similarly, a project can be debugged on various architectures using standard data exchange formats. The backplane provides a definition of uniform scripting language for all tools, which allows common initializing, debug and performance analysis language of all the tools.

The data exchange formats component 80 of the inter-tool backplane 40 provides a standard format for the following data exchange formats: input, output and log files; project settings; and packets exchange format. The tools generate the input/output/log files, which can be interchangeably used by other tools. An output file of a tool can be used as an input file to another tool. The log files can be standardized in format for use as system-level log files. The projects settings for every tool are in a standard format such that the CADS 20 can maintain a project setting for the whole system that every tool can use to identify their own specific project settings. The underlying tool can store additional project settings in its own format. Several tools receive and transmit packets to an external packet generator and analyzer. The data exchange formats component 80 standardizes the format at which the tools expect packets to be input and output in simulation mode. This standardization of the packet exhange format enables the use of a single packet generator/analyzer for the whole system and allows packets to be seamlessly transmitted from one tool to another.

The run-time module 74 is not essential for interactions between the various tools. Where needed, the run-time module 74 acts as a broker for interactions between tools.

The user interface 38 (shown in FIG. 2) includes a set of views, editors, perspectives and dialogs for use in cross-architecture code development and debugging. The user interface 38 allows the user to create a visual model of the user's hardware using a block diagram tool, with silicon elements properties and interconnections. It also allows the user to associate projects with the elements and launch debug sessions of multiple projects at the same time. Through the user interface the user can set cross-project breakpoints and view debugging data in one perspective.

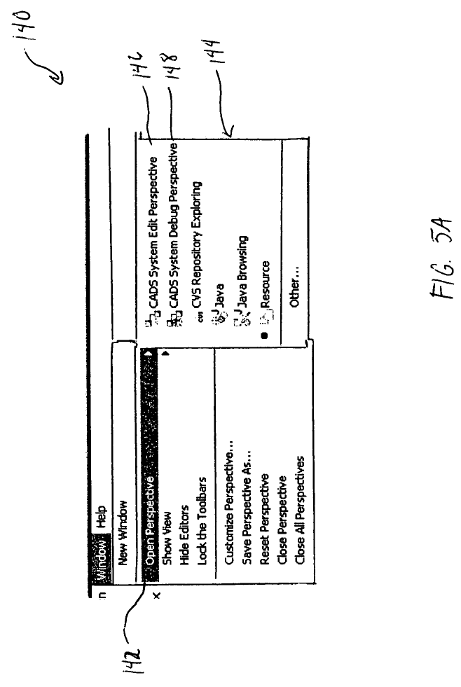

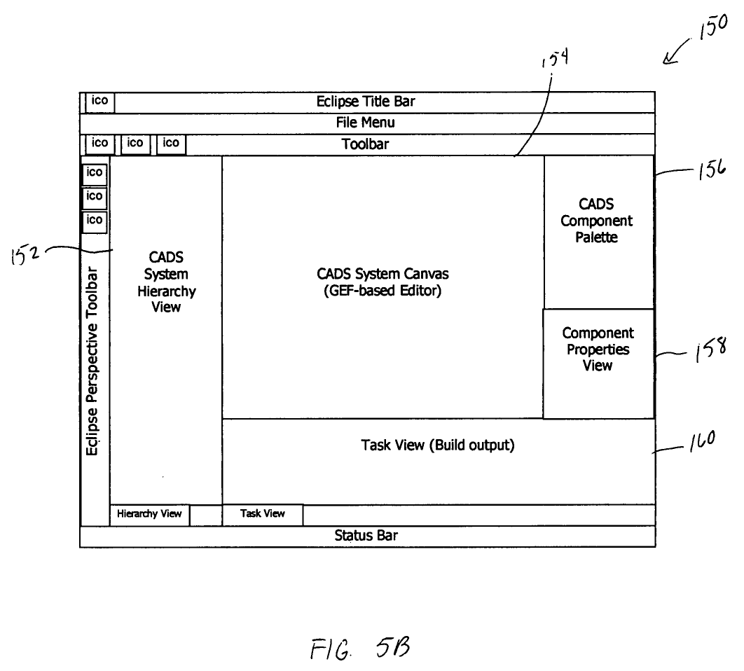

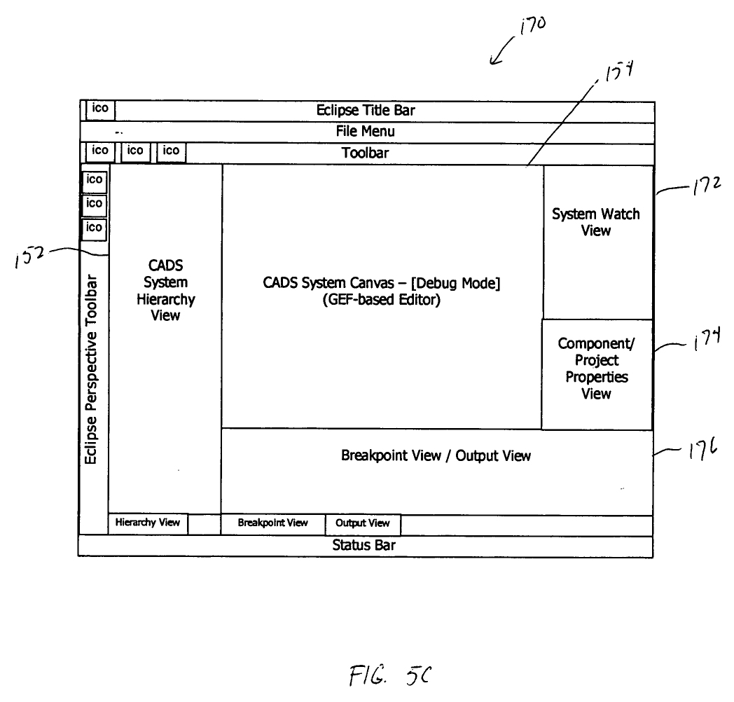

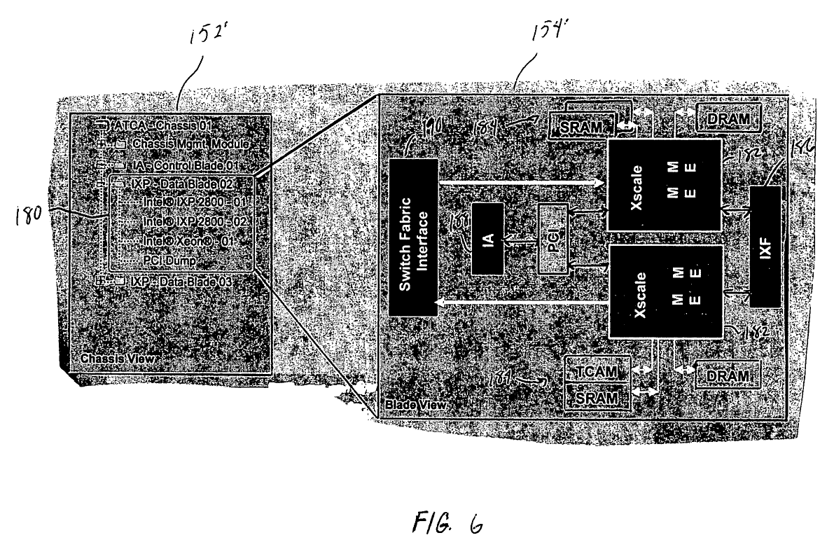

FIG. 5A shows an example screen 140 provided by the GUI and usable to open CADS perspectives. The perspectives can be opened by selecting an ‘open perspective’ option 142 to bring up an open perspective menu 144, which includes as exemplary perspective options a system edit perspective option 146 and a system debug perspective option 148.

Referring to FIG. 5B, an exemplary layout of a system edit perspective 150 is shown. This perspective contains the views necessary to create a model of a hardware system, configure the elements within the model, and define and configure interconnections between the elements. It also enables the user to associate software projects with elements in the model. The views include: a CADS system hierarchy view 152; a system canvas 154; a component palette view 156; a component properties view 158; and a task view 160. Other views may be provided as well.

Referring to FIG. 5C, an exemplary layout of a system debug perspective 170 is shown. The system debug perspective contains the views necessary to debug one or more of the software projects that have been associated with elements in the hardware system model. The views in this perspective include: a CADS system hierarchy view 152; a system canvas 154; a system watch view 172; a component/project properties view 174; and a breakpoint/output view 176. Other views may be provided as well. Thus, the views in this perspective will show data related to debugging such as system watches, breakpoints and status of each software project (e.g., ‘running’, ‘breakpoint hit’, ‘stopped’ and the like).

Details of the various perspective views will now be described in further detail with reference to FIGS. 5B and 5C. The system hierarchy view 152 within the system edit and debug perspectives provides the hierarchical organization of elements in the currently opened model in a tree view. The system canvas (editor) view 154 within the system edit and debug perspectives is the primary tool for creating a system model. It displays the elements of a single level of the model in a graphical block-diagram editor. It also shows the elements' interfaces and interconnections between the elements. The user can add and remove elements, arrange them on the screen, configure their interface properties, and connect them to one another. The component palette view 156 displays all of the model elements that are available for inclusion in a system model. They may be organized in a multi-folder view according to function of type. The user drag/drops the elements desired onto their system canvas. The task view 160 provides project build feedback, for example, it may provide a list of build messages from various projects. The component properties view 158 allows a user to view an element's properties when selected in the canvas or system hierarchy view. The system breakpoint view 176 shows the breakpoints set for projects being debugged. The system watch view 172 displays system watch variables from projects that have been associated with elements in the system model. Thus, the system-level view of the system edit and debug perspectives is the starting point for software architects and developers in creating a new design. It contains a graphical representation of the system, including the silicon components and their interconnection.

FIG. 6 shows an example of the system hierarchy view 152 for a bladed system (chassis), indicated by reference number 152′, and system canvas view 154 for a selected blade, indicated by reference numeral 154′. The system hierarchy view 152′ (labeled a “chassis view” in the figure) shows an “ATCA chassis” which includes a chassis management module, a control blade and two data blades. The control blade is implemented with an IA processor and the data blades are implemented with two IXP network processors each. A selected one of the data blade designs (indicated by reference numeral 180) is shown in the system canvas view 154′ (labeled a “blade view” in the figure). In this example, the blade view 154′ shows the selected blade design 180 as containing two IXP network processors 182 and their associated memories 184, an IXF framer 186, and embedded IA or IXC control plane and application processor 188, and a switch fabric interface 190. Note that the system level view is not intended to be a complete representation of the hardware design. Rather, it is intended to capture the silicon configuration (e.g. silicon type, types of interface, clock frequencies, allowed configurations, etc) and system configuration (e.g. component interconnection) information relevant to the software architects and development engineers. Once the system view has been created, it serves as the launch pad for both component specific actions (such as launching component specific tools) and system level actions.

The CADS 20 thus provides a visualization of the system and a mapping of tools to the system's sub-components. For instance, a chassis view provides a hierarchical view of each blade in the chassis, and each blade also has a view associated with it (as was illustrated in FIG. 6). When that view is opened, a graphical representation of the blade and its underlying features is displayed. The user can then click on areas of the blade view to launch tools associated with the blade feature. For instance, a blade could have a network connection component and when that component is selected (e.g., ‘double-clicked’) by the user, a network packet “sniffer” would launch and present the network traffic in a window.

As described earlier, a typical customer system design includes two or more processor architectures and thus usually two or more distinct tool sets. Each of these tool sets typically provides a project view that contains information on the files used in the project, build configurations, etc. The user interface 38 provides a system level project view, thus allowing project files, mapping of files to silicon components, build configurations and other project information to be managed in a single place and provided to the underlying tools.

The CADS 20 and associated component tools address all development phases, including evaluation, development, simulation, and integration. In the evaluation phase, the CADS 20 provides developers with the ability to carry out system level performance analysis across different processor architectures and make design partitioning decisions for the system. There is also a need for cross architecture development tools in the development phase. For example, teams developing data plane code for a network processor may need to develop code for two or more processing architectures (for example, the IXP network processor requires code development for both the XScale and ME portions of the chip). Such development is inherently cross-architecture and thus requires debugging and tuning across the different processing architectures.

In the simulation phase components are put together for the first time and tested at a system level. Primary tools in this phase are functional or cycle-accurate simulators. The environment in this phase needs to support multi-chip simulation for a full system ‘end-to-end’ packet flow analysis. The CADS 20 allows the development team to do early integration of the design in software using system level project/configuration views, integrated simulation tools, and cross architecture debug features. By doing early integration, developers can uncover issues early in the design cycle rather than at the end.

The execution phase involves debugging, testing and validating both the software and hardware components of the system. During the execution phase, the CADS 20 provides a system level view of execution (i.e., across multiple chips and/or boards). It also enables cross-architecture debugging and triggering by connecting individual debuggers via the inter-tool backplane 40.

In the past, the development and release of software for each of the specific processors and components would occur in isolation and the burden of performing system level integration placed completely on the users. Thus, developers would find system level software integration in systems that span multiple processors and system components a major challenge. When the customer system design process used separate tool environments for the data plane, management plane, and control plane, the system integration was done only in hardware. This meant that potential problems were identified late in the design cycle (often leading to significant changes in the original design to fix bugs and optimize performance). With no tools to debug the interactions between the functional planes, each tool set had to be used in isolation and any cross architecture debugging handled manually.

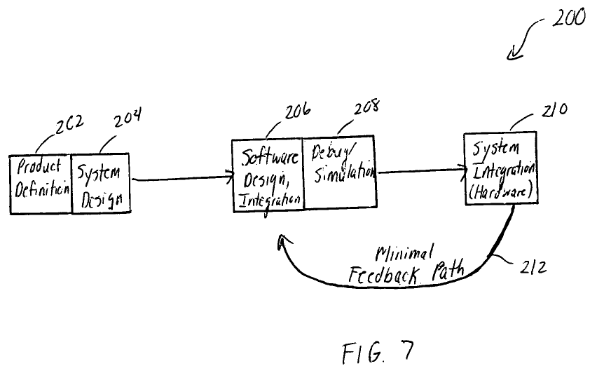

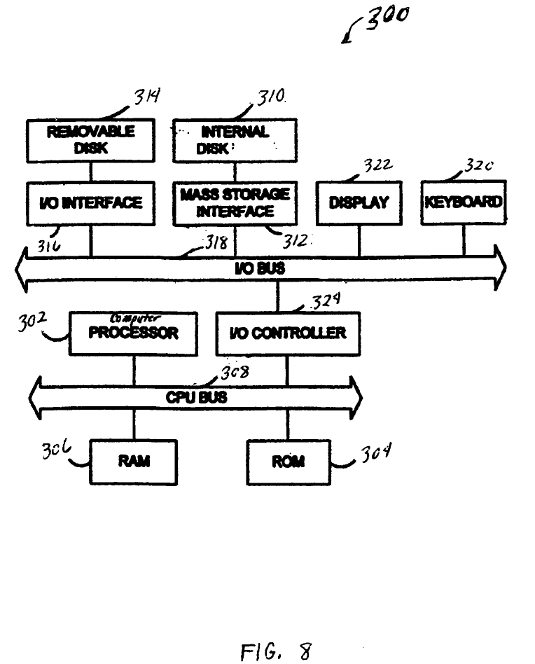

FIG. 7 shows an improved system design process 200 based on using the CADS 20. The process 200 includes a product definition stage 202 and system design stage 204, followed by software design and integration 206. The software design and integration 206 is followed by a debug and simulation stage 208. The debug and simulation stage is followed by a final system integration 210. The final system integration 210 is still done in hardware as before, but the CADS 20 allows early integration and simulation of the software components (as indicated at 206). The CADS 20 also provides cross-architecture debugging features to aid in debugging the interactions within and between the data plane, control plane, and management plane (at 208). These optimizations minimize the number of design changes detected late in the design cycle for a minimal feedback path to the earlier software design stage (as indicated by arrow 212).

Referring to FIG. 8, an exemplary computer system 300 suitable for use as system 12 as a development/debugger platform and, therefore, for supporting the upper-level application software 16, including the CADS 20, and any other processes used or invoked by such software, is shown. The upper-level application software 16 may be implemented in a computer program product tangibly embodied in a machine-readable storage device for execution by a computer processor 302; and methods of the CADS 20 may be performed by the computer processor 302 executing a program to perform functions of the CADS 20 by operating on input data and generating output.

Suitable processors include, by way of example, both general and special purpose microprocessors. Generally, the processor 302 will receive instructions and data from a read-only memory (ROM) 304 and/or a random access memory (RAM) 306 through a CPU bus 308. A computer can generally also receive programs and data from a storage medium such as an internal disk 310 operating through a mass storage interface 312 or a removable disk 314 operating through an I/O interface 316. The flow of data over an I/O bus 318 to and from devices 310, 314, (as well as input device 320, and output device 322) and the processor 302 and memory 306, 304 is controlled by an I/O controller 324. User input is obtained through the input device 320, which can be a keyboard (as shown), mouse, stylus, microphone, trackball, touch-sensitive screen, or other input device. These elements will be found in a conventional desktop computer as well as other computers suitable for executing computer programs implementing the methods described here, which may be used in conjunction with output device 322, which can be any display device (as shown), or other raster output device capable of producing color or gray scale pixels on paper, film, display screen, or other output medium.

Storage devices suitable for tangibly embodying computer program instructions include all forms of non-volatile memory, including by way of example semiconductor memory devices, such as EPROM, EEPROM, and flash memory devices; magnetic disks such as internal hard disks 310 and removable disks 314; magneto-optical disks; and CD-ROM disks. Any of the foregoing may be supplemented by, or incorporated in, specially-designed ASICs (application-specific integrated circuits).

Typically, the application software 16 and other related processes reside on the internal disk 310. These processes are executed by the processor 302 in response to a user request to the computer system's operating system in the lower-level software 18 after being loaded into memory. Any files or records produced by these processes may be retrieved from a mass storage device such as the internal disk 310 or other local memory, such as RAM 306 or ROM 304.

The system 12 (of FIG. 1) is illustrated in a system configuration in which the application software 16 is installed on a single stand-alone or networked computer system for local user access. In an alternative configuration, e.g., the software or portions of the software may be installed on a file server to which the system 12 is connected by a network, and the user of the system accesses the software over the network. The software instructions may be disposed on an article of manufacture (e.g., a non-volatile storage medium).

Other embodiments are within the scope of the following claims.

What is claimed is:

1. A method comprising:
providing a user interface common to multiple development tools, different ones of the development tools dedicated to different processor architectures; and
enabling communications between the user interface and the development tools.

2. The method of claim 1 wherein enabling communications comprises:
using an inter-tool backplane to couple the user interface to the development tools.

3. The method of claim 2 wherein enabling communications further comprises:
using the inter-tool backplane to enable cross-architecture interactions between the development tools.

4. The method of claim 3 wherein the inter-tool backplane comprises application programming interfaces common to the development tools.

5. The method of claim 3, wherein the inter-tool backplane comprises a data exchange formats component to provide a standardized data exchange format for the cross-architecture interactions.

6. The method of claim 3 wherein the inter-tool backplane further comprises configuration files to maintain configuration parameters and metadata for the development tools.

7. The method of claim 3 wherein the inter-tool backplane further comprises a tools registry for registering the development tools with the inter-tool backplane.

8. The method of claim 1 wherein the development tools include sets of multiple tools targeted at the same processing architecture.

9. The method of claim 8 wherein each tools set includes a tool from one or more functional tools categories.

10. The method of claim 1 wherein the user interface comprises one or more system-level views for viewing a graphical depiction of target system hardware, the depiction including at least one graphic identification of at least one of the processing architectures

11. The method of claim 1 wherein the different processing architectures include a general purpose processing architecture and a network processor architecture.

12. An article comprising:
a storage medium having stored thereon instructions that when executed by a machine result in the following:
providing a user interface common to multiple development tools, different ones of the development tools dedicated to different processor architectures; and
enabling communications between the user interface and the development tools.

13. The article of claim 12, wherein enabling communications comprises:
using an inter-tool backplane to couple the user interface to the development tools.

14. The article of claim 13 wherein enabling communications further comprises:
using the inter-tool backplane to enable cross-architecture interactions between the development tools.

15. The article of claim 14 wherein the inter-tool backplane comprises application programming interfaces common to the development tools.

16. The article of claim 14, wherein the inter-tool backplane comprises a data exchange formats component to provide a standardized data exchange format for the cross-architecture interactions.

17. The article of claim 14 wherein the inter-tool backplane further comprises configuration files to maintain configuration parameters and metadata for the development tools.

18. The article of claim 14 wherein the inter-tool backplane further comprises a tools registry for registering the development tools with the inter-tool backplane.

19. The article of claim 12 wherein the development tools include tools sets targeted at each of the different processing architectures.

20. The article of claim 19 wherein each tools set includes a tool from one or more functional tools categories.

21. The article of claim 12 wherein the user interface comprises one or more system-level views for viewing a graphical depiction of target system hardware.

22. The article of claim 12 wherein the different processing architectures include a general purpose processing architecture and a network processor architecture.

23. A development platform comprising:
development tools, different ones of the development tools dedicated to different processor architectures;
a user interface common to the development tools; and
an inter-tool backplane to enable communications between the user interface to the one or more development tools, the inter-tool backplane exposing an application programmer interface (API) to the development tools.

24. The development platform of claim 23 wherein the inter-tool backplane is usable to couple the user interface to the development tools.

25. The development platform of claim 24 wherein the inter-tool backplane is usable to enable cross-architecture interactions between the development tools.

26. The development platform of claim 25 wherein the inter-tool backplane comprises application programming interfaces common to the development tools and a data exchange formats component to provide a standardized data exchange format for the cross-architecture interactions.

27. The development platform of claim 25 wherein the inter-tool backplane further comprises configuration files to maintain configuration parameters and metadata for the development tools.

28. The development platform of claim 25 wherein the inter-tool backplane further comprises a tools registry for registering the development tools with the inter-tool backplane.

29. The development platform of claim 23 wherein the development tools include tools sets targeted at each of the different processing architectures.

30. The development platform of claim 29 wherein each tools set includes a tool from one or more functional tools categories.

31. The development platform of claim 23 wherein the user interface comprises one or more system-level views for viewing a graphical depiction of target system hardware.

32. The development platform of claim 23 wherein the different processing architectures include a general purpose processing architecture and a network processor architecture.

33. An article of manufacture comprising instructions to cause a processor to:
send data to multiple development tools, different ones of the development tools dedicated to different processor architectures included in a system; and
receive data from the multiple development tools.

34. The article of claim 33 wherein the instructions further comprise instructions to cause the processor to:
provide a user interface to display data received from the multiple development tools.

35. The article of claim 33, wherein the development tools comprise at least one selected from a group including: (1) a debugger and (2) a simulator.

36. The article of claim 33, wherein the instructions to send data comprise instructions to send data via Application Programmer Interfaces (APIs) exposed by the respective development tools.

37. The article of claim 33 wherein the instructions comprise instructions of an inter-tool backplane to enable cross-architecture interactions between the development tools.

38. The article of claim 37, wherein the inter-tool backplane comprises a data exchange formats component to provide a standardized data exchange format for the cross-architecture interactions.

39. The article of claim 37, wherein the instructions to send data and the instructions to receive data comprise instructions to send data to a one of the multiple tools received from another one of the multiple tools.
